(19) United States
(12) Patent Application Publication
(10) Pub. No.: US 2008/0235030 A1
(43) Pub. Date: Sep. 25, 2008

(54) Automatic Method For Measuring a Baby's, Particularly a Newborn's, Cry, and Related Apparatus

(75) Inventors: Renata Sisto, Catone Rm (IT); Carlo Valerio Bellieni, Siena (IT); Giuseppe Buonocore, Siena (IT)

Correspondence Address: ROBERTS MLOTKOWSKI SAFRAN & COLE, P.C., P. O. BOX 10064, MCLEAN, VA, 22102-8064, US

(73) Assignees: UNIVERSITA' DEGLI STUDI DI SIENA, Siena (IT); AZIENDA OSPEDALIERA UNIVERSITARIA SENESE, Siena (IT)

(21) Appl. No.: 11/817,927

(22) PCT Filed: Mar. 10, 2006
(86) PCT No.: PCT/IT06/00145

§ 371 Date: Oct. 15, 2007

(30) Foreign Application Priority Data
Mar. 11, 2005 (IT) RM2005A000110

(51) Int. Cl. G10L 17/00; G10L 21/06

(52) U.S. Cl. 704/275; 704/236; 704/E11.006

(57) ABSTRACT

The present invention concerns an automatic method for measuring a baby's cry, comprising the following step: A. having N samples ρ(i), for i=O, 1, . . . , (N−1), of an acoustic signal p(t) representing the cry, sampled at a sampling frequencŷ for a period of duration P; the method being characterised in that it assigns a score PainScore to the acoustic signal p(t) by means of a function AF of one or more acoustic parameters selected from the group comprising: —a root-mean-square or rms value prms of the acoustic signal p(t) in the period P; —a fundamental or pitch frequency F0 of the acoustic signal p(t), i.e. the minimum frequency at which a peak in the spectrum of the acoustic signal p(t) occurs in the period P; and—a configuration of amplitude and frequency modulation of the acoustic signal p(t) in the period P. The invention further concerns the apparatus performing the method.

The present invention relates to an automatic method for measuring a baby's, particularly a newborn's, cry, and the related apparatus, that allows in a simple, reliable, and inexpensive way to provide an indication of the pain level suffered by the baby starting from the analysis of his/her cry acoustic characteristics.

Pain has different levels, quantifiable from zero up to a maximum, and the behaviour of babies consequently varies. In the last years, pain scales have been developed for discriminating the level of pain suffered by a newborn.

By way of example, the score scale known as Newborn's Sharp Pain, or DAN (Douleur Aiguë Nouveau-né), evaluates facial expressions, limb movements, and newborn's vocalizations for generating a score ranging from 0 (corresponding to lack of pain) and 10 (corresponding to maximum pain).

However, such scales are hardly usable, since they cannot be easily automated so as to provide objective and repeatable indications, because they require an active evaluation by an operator.

It is therefore an object of the present invention to provide in a simple, reliable, and inexpensive way an automatic, and hence objective and repeatable, indication of a baby's, in particular a newborn's, pain level.

It is specific subject matter of the present invention an automatic method for measuring a baby's cry, comprising the following step:
A. having N samples p(i), for i=0, 1, . . . , (N−1), of an acoustic signal p(t) representing the cry, sampled at a sampling frequency fₛ for a period of duration P;
   the method being characterised in that it assigns a score PainScore to the acoustic signal p(t) by means of a function AF of one or more acoustic parameters selected from the group comprising:
   a root-mean-square or rms value pᵣₘₛ of the acoustic signal p(t) in the period P;
   a fundamental or pitch frequency F₀ of the acoustic signal p(t), i.e. the minimum frequency at which a peak in the spectrum of the acoustic signal p(t) occurs in the period P; and
   a configuration of amplitude and frequency modulation of the acoustic signal p(t) in the period P.

In other words, the automatic method according to the invention measures a baby's, in particular a newborn's, cry starting from its time and/or spectral acoustic analysis.

In particular, the method is based on recording and analysing newborn's cry. The pain level is preferably assigned through the combined evaluation of a set of one or more measurable acoustic parameters, which are related to the pain level. A quantitative estimate of the pain level is obtained on the basis of a validated pain scale, based on the cry acoustic characteristics.

The acoustic parameters used for the diagnosis comprise one or more of the following three ones: the fundamental or pitch frequency; the normalised amplitude, with respect to the maximum value, of the root-mean-square or rms value; and the presence of a specific characteristic of cry frequency and amplitude modulation, which characteristic is defined as “siren cry”. The method provides as output value a score, preferably ranging from 0 to 6, that is proposed as an adequate scale for describing the pain level.

Further characteristics of other embodiments of the method according to the invention are defined in the enclosed claims 2-29.

It is still subject matter of the present invention an apparatus for measuring a baby's cry, comprising processing means, characterised in that it is capable to perform the previously described automatic method for measuring a baby's cry, the apparatus preferably further comprising means for detecting acoustic signals, and sampling means, capable to sample said acoustic signals.

In other words, the apparatus according to the invention performs the aforementioned automatic method for measuring a baby's cry, through an automatic acoustic analysis of the newborn's cry, in order to provide an objective estimate of the newborn's pain level.

The present invention will now be described, by way of illustration and not by way of limitation, according to its preferred embodiments, by particularly referring to the Figures of the enclosed drawings, in which:

FIG. 1 shows a flow chart of a preferred embodiment of the method according to the invention;

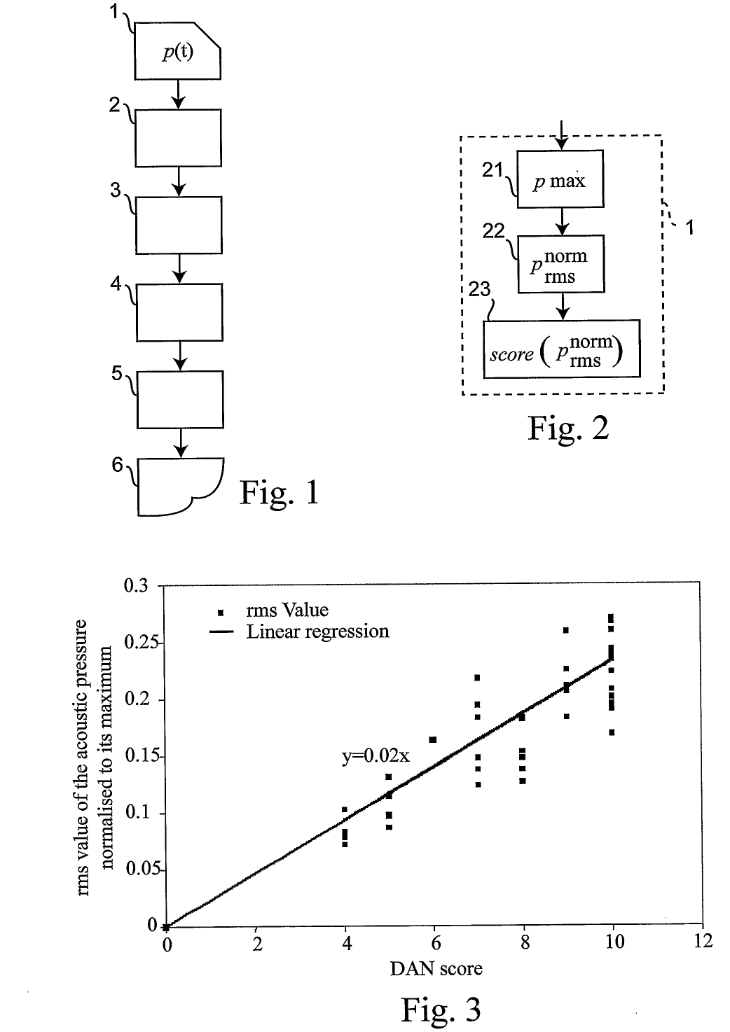

FIG. 2 shows a detailed flow chart of step 2 of the method of FIG. 1;

FIG. 3 shows a graph of the rms values of normalised acoustic signals during cry sequences of 24 seconds as a function of the DAN scale;

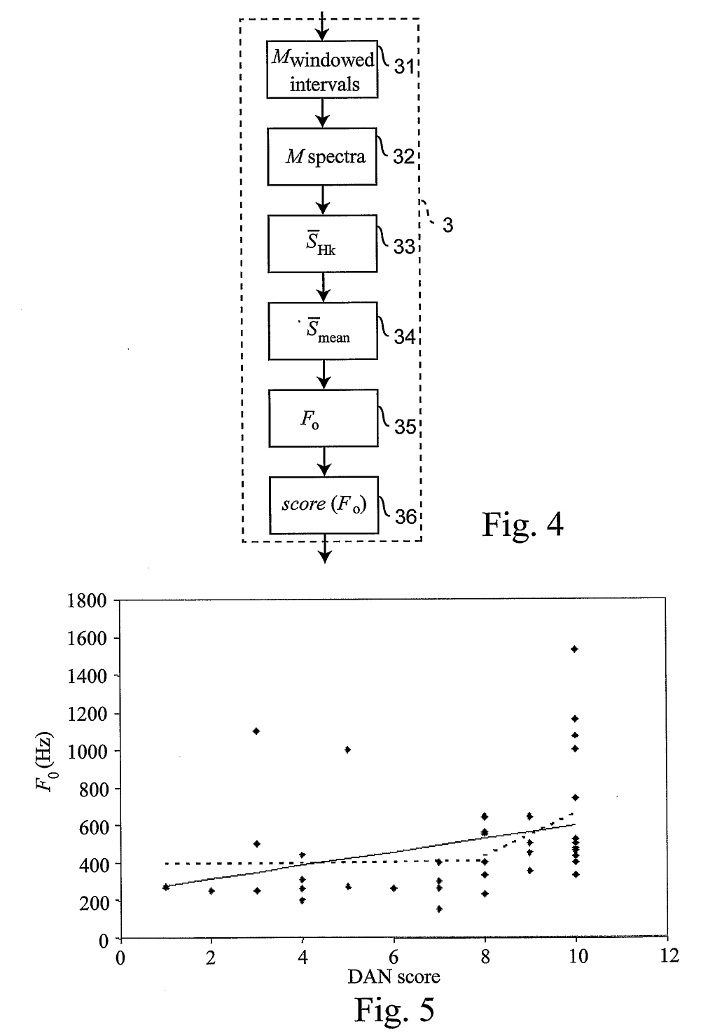

FIG. 4 shows a detailed flow chart of step 3 of the method of FIG. 1;

FIG. 5 shows a graph of the values of the fundamental frequency F₀ as a function of the DAN scale; and

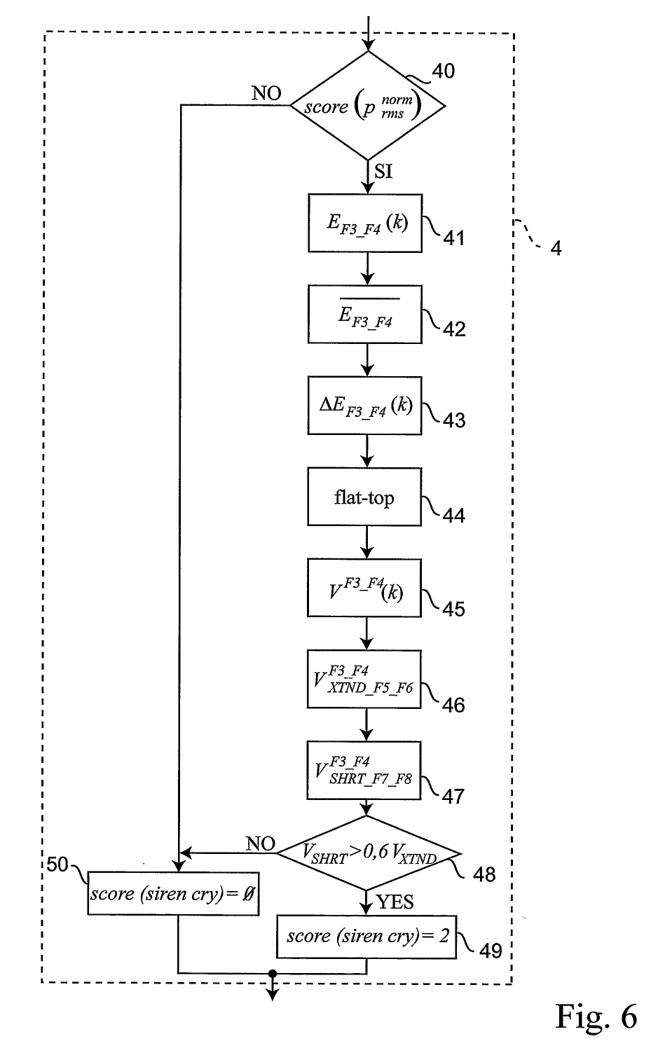

FIG. 6 shows a detailed flow chart of step 4 of the method of FIG. 1.

In the following of the description same references will be used to indicate alike elements in the Figures.

As mentioned, the cry acoustic parameters which are measured by the method according to the invention for providing a measure of the cry, indicative of the pain level suffered by the baby, comprise:
the normalised amplitude, with respect to the maximum value, of the root-mean-square or rms value of the acoustic signal;
the fundamental frequency or pitch of the acoustic signal;
the persistence of regular configurations of frequency and amplitude modulation (configurations defined as “siren cry”).

The higher the values of such acoustic parameters are, the higher is the pain level of the baby.

The normalised to its maximum value rms value is not a measure of the cry absolute intensity, but it is rather a measure of the emission constancy: in other words, it measures the fraction of the observation time along which the signal is close to its maximum. This is related to the pain level, since a suffering newborn tends to cry for long time close to its maximum reachable level. Preferably, a normalised rms value over 0.15-0.2 is associated with high pain levels.

The fundamental frequency or pitch is typically higher in cry caused by pain. A pitch frequency over 350-450 Hz is typically correlated with high pain levels.

Another specific characteristic of cry due to a high pain is the regularity and reproducibility of the configurations of amplitude and frequency modulation on a short time scale, of the order of 1 second, which configurations define the so-called siren cry, with a persistent configuration lasting several periods. The time-frequency intensity configuration of this siren cry shows a periodical modulation of the fundamental frequency F₀ and of its multiple frequencies, while the mean power spectrum has a quasi-periodical peak structure.

All the three cry acoustic parameters described above are correlated with the pain level, independently evaluated by using the DAN score scale.

With reference to FIG. 1, it may be observed that a preferred embodiment of the method according to the invention comprises a step 1 of acquiring N samples p(i), for i=0, 1, . . . , (N−1), of the acoustic signal p(t) that is sampled at a suitable sampling frequency fₛ (taking into account that the Nyquist frequency is equal to f₂/2) for a period of duration P. Preferably, P is not shorter than 20 seconds, and N is equal to an involution of 2 (N=2^{A}).

Afterwards, the method comprises a step 2 of processing a first score on the basis of the root-mean-square value in the period P of the N samples p(i) of the acoustic signal p(t).

The method still comprises a step 3 of processing a second score on the basis of the fundamental or pitch frequency F₀ of the acoustic signal p(t), that is on the basis of the minimum frequency at which a peak in the spectrum of the acoustic signal p(t) occurs.

Furthermore, the method comprises a step 4 of processing a third score on the basis of the characteristic defined as “siren cry”, preferably not null only in case of persistent cry, i.e. with value of the first score larger than a corresponding threshold value.

Finally, the method comprises a step 5 of adding up the three calculated scores, that is given as output in a step 6.

With reference to FIG. 2, it may be observed that step 2 comprises:
a sub-step 21 of determining the maximum amplitude Oman of the acoustic signal p(t) in the period P:

$${p}_{max} = {max}_{i = 0 , 1 , … , ( N - 1 )} \{ p ( i ) \}$$

a sub-step 22 of calculating the root-mean-square value of the acoustic signal p(t), normalised to its maximum amplitude pₘₐₓ, in the period P:

$${p}_{rms}^{norm} = \sqrt{\frac{1}{N} {\sum }_{i = 0}^{( N - 1 )} {( \frac{p ( i )}{{p}_{max}} )}^{2}}$$

a sub-step 23 of assigning the first score to the normalised rms value pᵣₘₛ^{norm}, by means of a first, either continuous or discrete, preferably monotonic not decreasing, function g₁(pᵣₘₛ^{norm}).

In particular, FIG. 3 shows the rms values of the normalised acoustic pressure during a cry sequence of 24 seconds, as a function of the DAN scale.

Preferably the first function g₁(pᵣₘₛ^{norm}) is continuous, more preferably equal to:

$$score ( {p}_{rms}^{norm} ) = \frac{2}{π} arctan ( α ( {p}_{rms}^{norm} - β ) ) + 1 \qquad [ 1 ]$$

where coefficients α and β are preferably equal to the following values:

α=100

β=0.14 [2]

so that the values of score(pᵣₘₛ^{norm}) meet the following conditions:

for pᵣₘₛ^{norm}<<0.1 it is score(pᵣₘₛ^{norm})≈0

for pᵣₘₛ^{norm}=0.1 it is score(pᵣₘₛ^{norm})=0.15

for pᵣₘₛ^{norm}=0.14 it is score(pᵣₘₛ^{norm)=}1

for pᵣₘₛ^{norm}=0.18 it is score(pᵣₘₛ^{norm})=1.85

for pᵣₘₛ^{norm}>>0.18 it is score(pᵣₘₛ^{norm})≈2

Alternatively, the first function g₁(pᵣₘₛ^{norm}) may be discrete, so that the possible values of pᵣₘₛ^{norm} are subdivided into at least two ranges to which a respective value of score(pᵣₘₛ^{norm}) corresponds. Preferably, such discrete function may be the following:

$$score ( {p}_{rms}^{norm} ) = \{ \begin{matrix}0 & per & 0 \leq {p}_{rms}^{norm} < 0 , 1 & \\ 1 & per & 0 , 1 \leq {p}_{rms}^{norm} < 0 , 18 & \\ 2 & per & {p}_{rms}^{norm} \geq 0 , 18 & \end{matrix}$$

With reference to FIG. 4, it may be observed that step 3 of FIG. 1 comprises a sub-step 31 of subdividing the N samples p(i) into M time intervals, of duration equal to D=P/M, wherein M is preferably equal to an involution of 2 (M=2^{B}, with B≦A), each one of which hence comprises N_{D} samples, with

N_{D}=N/M=2^{(A-B)}.

In order to avoid in the successive frequency analysis the introduction of spurious spectral characteristics caused by cutting the waveform off, in sub-step 31 a Hanning window W_{H}(j) (for 0, 1, . . . , (N_{D}−1)) is applied to each interval, thus obtaining, for each one of the M intervals, N_{D} samples p_{Hk}(j) (where k is the interval index, i.e. k=0, 1, . . . , (M−1));

p_{Hk}(j)=p(N_{D}·k+j)·W_{H}(j)
for j . . . , (N_{D}−1) and k=0, 1, . . . , (M−1)

In successive sub-step 32, it is calculated for each interval the power spectrum of the digitised signal:

S_{Hk}(j)=FT_{ND}{p_{Hk}(j)}
for j=0, 1, . . . , (N_{D}−1) and k=0, 1, . . . , (M−1)

where y(j)=FT_{ND}{x(j)} indicates the operator FT_{ND} (preferably the Fourier transform of the autocorrelation function) that transforms N_{D} samples x(j) from the time domain to N_{D} samples y(j) in the frequency domain. As a consequence, in sub-step 32 it is obtained a time sequence of M spectra, each one with a frequency resolution R_{f} equal to:

R_{f}=fₛ/N_{D}

and a bandwidth B1 equal to the Nyquist frequency:

B1=fₛ/2.

Afterwards, in sub-step 33 it is calculated the mean spectrum S̅_̅{̅H̅k̅}̅(j) of the M spectra:

$$\begin{matrix}\overline{{S}_{Hk}} ( j ) = \frac{1}{M} {\sum }_{k = 0}^{M - 1} {S}_{Hk} ( j ) & for j =\end{matrix} 0 , 1 , … , ( {N}_{D} - 1 )$$

Sub-step 34 determines the mean value Sₘₑₐₙ of the mean spectrum S̅_̅{̅H̅k̅}̅(j) in a first frequency range included between two respective frequency limit values F₁ and F₂ (to which two indexes correspond j₁=F₁/R_{f} and j₂=F₂/R_{f}), preferably included within the low frequency part of the spectrum bandwidth B1:

$${S}_{mean} = \overline{{S}_{Hk}} ( j ) = \frac{1}{( \frac{{F}_{2} - {F}_{1}}{{R}_{f}} + 1 )} {\sum }_{j = \frac{F 1}{Rf}}^{\frac{F 2}{Rf}} \overline{{S}_{Hk}} ( j )$$

Sub-step 35 determines the pitch F₀ as the minimum frequency at which a peak of the mean power spectrum S̅_̅{̅H̅k̅}̅(j) occurs. In particular, sub-step 35 determines the frequency F₀ as the one corresponding to the first peak of the mean spectrum (i.e. to the first relative maximum) the value of which is larger than a threshold T1, preferably equal to the mean level Sₘₑₐₙ of the mean spectrum added to an offset value Δ1, possibly even negative, preferably equal to 5 dB:

F₀=R_{f}·min{j|max_relative[ S̅_̅{̅H̅k̅}̅(j)]>T1=Sₘₑₐₙ+Δ}

This definition of the pitch F₀ is independent from the absolute calibration.

In particular, FIG. 5 shows the values of the fundamental frequency F₀, as a function of the DAN scale. The continuous line is an interpolation of all the data, while the two dotted lines are two different interpolations for the data related to cries of newborns with DAN≦8 and with DAN≧8.

Still with reference to FIG. 4, step 3 finally comprises a sub-step 36 of assigning the second score to the value of fundamental frequency or pitch F₀, by means of a second, either continuous or discrete, preferably monotonic not decreasing, function g₂(F₀).

Preferably the second function g₂(F₀) is continuous, more preferably equal to:

$$score ( {F}_{0} ) = \frac{2}{π} arctan ( γ ( {F}_{0} - δ ) ) + 1 \qquad [ 3 ]$$

where coefficients γ and δ are preferably equal to the following values:

γ=100

δ=0.4 [4]

so that the values of score(F₀) meet the following conditions:

for F₀<<350 Hz it is score(F₀)≈0

for F₀=350 Hz it is score(F₀)=0.13

for F₀=400 Hz it is score(F₀)=1

for F₀=450 Hz it is score(F₀)=1.87

for F₀>>450 Hz it is score(F₀)≈2

Alternatively, the second function g₂(F₀) may be discrete, so that the possible values of F₀ are subdivided into at least two ranges to which a respective value of score(F₀) corresponds. Preferably, such discrete function may be as follows:

$$score ( {F}_{0} ) = \{ \begin{matrix}0 & for & {F}_{0} < 400 Hz \\ 2 & for & {F}_{0} \geq 400 Hz\end{matrix}$$

With reference to FIG. 6, it may be observed that step 4 of FIG. 1 comprises a sub-step 41 in which, for each digitised power spectrum S_{Hk}(j) of the signal, obtained in sub-step 32 of FIG. 4, it is calculated the energy contribution E_{F3}_{_{—}}_{F4}(k) in a second frequency range included between two respective frequency limit values F₃ and F₄ (to which two indexes j₃=F₃/R_{f} and j₄=F₄/R_{f} correspond), preferably included within the low frequency part of the spectrum bandwidth B1. In other words, it is calculated the integral (i.e., the sum of the digitised values) of the spectrum between F₃ and F₄:

$${E}_{F3\_F 4} ( k ) = {\sum }_{j = F 3 / Rf}^{F 4 / Rf} {S}_{Hk} ( j )$$

$$for k = 0 , 1 , … , ( M - 1 )$$

In sub-step 42, it is calculated the mean value E̅_̅{̅F̅3̅}̅_̅{̅_̅}̅_̅{̅F̅4̅}̅ along time of the energy contribution E_{F3}_{_{—}}_{F4}(k):

$$\overline{{E}_{F3\_F4} ( k )} = \frac{1}{M} {\sum }_{k = 0}^{M - 1} {E}_{F3\_F4} ( k )$$

In sub-step 43, it is calculated the deviation ΔE_{F3}_{_{—}}_{F4}(k) of the energy contribution E_{F3}_{_{—}}_{F4}(k) in the second frequency range with respect to its mean value E̅_̅{̅F̅3̅}̅_̅{̅_̅}̅_̅{̅F̅4̅}̅:

ΔE_{F3}_{_{—}}_{F4}(k)=E_{F3}_{_{—}}_{F4}(k)− E̅_̅{̅F̅3̅}̅_̅{̅_̅}̅_̅{̅F̅4̅}̅
for k=0, 1, . . . , (M−1)

In sub-step 44, a window W_{flat-top}(k) (for k=0, 1, . . . , (M−1)) having spectrum with flat top main lobe, known as flat-top window, is applied to such deviation, thus obtaining M samples ΔE_{F3}_{_{—}}_{F4}^{flat-top}(k):

ΔE_{F3}_{_{—}}_{F4}^{flat-top}(k)=ΔE_{F3}_{_{—}}_{F4}(k)·W^{flat-top}(k)
for k=0, 1, . . . , (M−1)

In next sub-step 45, it is calculated the digitised power spectrum V^{F3}^{_{—}}^{F4}(k) of the signal ΔE_{F3}_{_{—}}_{F4}^{flat-top}(k) obtained from sub-step 44, that is indicative of the frequency components of the variation dynamics of the energy contribution E_{F3}_{_{—}}_{F4}(k) in the second frequency range:

V^{F3}^{_{—}}^{F4}(k)=FT_{M}{ΔE_{F3}_{_{—}}_{F4}^{flat-top}(k)}
for k=0, 1, . . . , (M−1)
   thus obtaining M samples V^{F3}^{_{—}}^{F4}(k) in the frequency domain, with frequency resolution VR_{f} equal to:

VR_{f}=fₛ/N

and a bandwidth B2 equal to:

B2=fₛ/(2·N_{D}).

In next sub-step 46, it is calculated the energy contribution V_{XTND}_{_{—}}_{F5}_{_{—}}_{F6}^{F3}^{_{—}}^{F4} in a third frequency range included between two respective frequency limit values F₅ and F₆ (to which two indexes k₅=F₅/VR_{f} and k₆=F₆/VR_{f} correspond), the preferably excludes only the end at lowest frequency of the spectrum V^{F3}^{_{—}}^{F4}(k). In other words, it is calculated the integral (i.e., the sum of the digitised values) of the spectrum V^{F3}^{_{—}}^{F4}(k) between F₅ and F₆:

$${V}_{XTIND\_F5 \_F6}^{F3\_F4} = {\sum }_{k = F 5 / VRf}^{F 6 / VRf} {V}^{F3\_F4} ( k )$$

In next sub-step 47, it is calculated the energy contribution V_{SHRT}_{_{—}}_{F7}_{_{—}}_{F8}^{F3}^{_{—}}^{F4} in a fourth frequency range included between two respective frequency limit values F₇ and F₈ (to which two indexes k₇=F₇/VR_{f} and k₈=F₈/VR_{f} correspond), preferably included within the part at frequency around 1 Hz of the spectrum V^{F3}^{_{—}}^{F4}(k), more preferably included within the third frequency range. In other words, it is calculated the integral (i.e., the sum of the digitised values) of the spectrum V^{F3}^{_{—}}^{F4}(k) between F₇ and F₈:

$${V}_{SHRT\_F7 \_F8}^{F3\_F4} = {\sum }_{k = F 7 / VRf}^{F 8 / VRf} {V}^{F3\_F4} ( k )$$

Afterwards, step 4 evaluates the presence and, possibly, the level of the so-called siren cry on the basis of a comparison of the energy contribution V_{SHRT}_{_{—}}_{F7}_{_{—}}_{F8}^{F3}^{_{—}}^{F4} in the fourth frequency range with the energy contribution V_{XTND}_{_{—}}_{F5}_{_{—}}_{F6}^{F3}^{_{—}}^{F4} in the third frequency range of the spectral dynamics V^{F3}^{_{—}}^{F4}(k), consequently assigning the third score in relation to such possible characteristic of the siren cry. In particular, the third score score(sirencry) is advantageously assigned by means of a third, either continuous or discrete, preferably monotonic not decreasing, function g₃(V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}) of the difference between the two mentioned energy contributions (V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}).

Preferably, the third function g₃(V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}) is discrete, with two intervals of membership for the difference (V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}), to which a respective score value score(sirencry) corresponds.

In fact, as shown in FIG. 6, step 4 of FIG. 1 comprises a sub-step 48 in which it is verified if the energy contribution V_{SHRT}_{_{—}}_{F7}_{_{—}}_{F8}^{F3}^{_{—}}^{F4} within the fourth frequency range is larger than 60% of the energy contribution V_{XTND}_{_{—}}_{F5}_{_{—}}_{F6}^{F3}^{_{—}}^{F4} within the third frequency range. In the positive, the siren cry characteristic is considered as present, and sub-step 49 is performed, in which a value equal to 2 is assigned to the third score:

score(siren cry)=2

Instead, in the case when the verification of sub-step 48 gives a negative outcome, the siren cry characteristic is considered as absent, and sub-step 50 is performed, in which a null value is assigned to the third score:

score(siren cry)=0

Such score is preferably also assigned in the case when there is no persistent cry, i.e. in the case when the normalised rms value of the acoustic signal is low. As shown in FIG. 6, such condition is achieved through a preliminary sub-step 40 of step 4 verifying that the first score score(pᵣₘₛ^{norm}) depending on the normalised rms value is larger than a respective threshold T2, more preferably equal to 1.85.

In the case when the verification of sub-step 40 has a positive outcome, i.e. a persistent cry has been recognised, then step 4 of FIG. 1 continues with the successive sub-steps 41-48 of FIG. 6, illustrated above.

Otherwise, i.e. in the case when the verification of sub-step 40 has a negative outcome, step 4 of FIG. 1 directly continues with sub-step 50 of assigning a null value to the third score score(siren cry).

Alternatively, the third function g₃(V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}) is discrete, with more than two intervals of membership for the difference (V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}), to which a respective score value score(sirencry).

Still alternatively, the third function g₃(V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}) may be continuous.

In the following a prototype made by the inventors is illustrated, that operates according to a preferred embodiment of the method according to the invention for discriminating different pain levels. In particular, the prototype has been tested by analysing the cry, during heel prick, of 57 newborns, the pain intensity of which has been independently evaluated according the DAN index.

The acoustic signal coming from a ½ inch (i.e. 1.27 cm) microphone, with a 50 mV/Pa sensitivity, has been sample at a frequency of 44.1 kHz, corresponding to a Nyquist frequency of 22.05 kHz. This frequency corresponds to the standard sampling rate of commercial audio devices. A digitised electronic files of about 23.77 s of duration (thus comprising N=2²⁰ samples) has been extracted by each recording, starting from a given time t₀ established by the operator.

The digitised waveform has been divided into M=256 (equal to 2⁸) time intervals, each one of about 92.88 ms of duration. The signal power spectrum has been calculated for each interval for providing a time sequence of 256 spectra for each newborn, with a frequency resolution of about 10.77 Hz. As said, in order to avoid the introduction of spurious spectral characteristics caused by cutting the waveform off, a Hanning window has been applied to each interval. Time evolution of these spectra has been displayed as time-frequency intensity graphs, which may be used for a preliminary heuristic analysis. The acoustic pressure signal p(t) of each cry sequence has been normalised to its maximum amplitude pₘₐₓ. The rms value of the normalised acoustic pressure has been calculated for each waveform. A first score has been assigned to the normalised rms value by means of the continuous function [1] that is optimised as in [2].

It has been then calculated the mean of the 256 spectra, in order to determine the pitch F₀ as the minimum frequency at which a peak of the mean power spectrum occurs. In particular, a peak has been considered as such when the signal exceeds by at least 5 dB the mean level of the spectrum within the frequency range 3-7.5 kHz.

A third score has been assigned to the pitch value F₀ by means of the continuous function [3] that is optimised as in [4].

It has been then performed the automatic procedure for recognising the “siren cry”, which is only applied in case of persistent cry, i.e. with pain score due to a normalised rms value larger than a threshold (equal to 1.85). In particular:
it has been calculated a spectrogram (i.e. the graph of the sound spectral composition as time varies) with time resolution of about 0.093 s;
the spectrogram has been frequency integrated from 2 to 8 kHz, obtaining an integrated signal that is a time function with a time resolution equal to about 0.093 s;
the mean value of the signal has been subtracted from the same;
a flat-top window has been applied to the thus obtained zero mean signal;
it has been calculated the power spectrum thereof;
it has been calculated the energy within the frequency range of 0.6-1.7 Hz;
the presence of the “siren cry” has been assigned to the cry signal if the energy within the frequency range of 0.6-1.7 Hz is larger than 60% of the total energy within the range of 0.4-5.3 Hz.

The pain score as illustrated in FIG. 6 has been assigned to the presence of the “siren cry”, i.e.:

in the case when the siren cry is present,

score(siren cry)=2;

in the case when the siren cry is absent,

score(siren cry)=0.

The total score PainScore, equal to the sum of the three (possibly weighed) scores which are calculated with respect to the three characteristics of the cry acoustic signal:

PainScore=score(pᵣₘₛ^{norm})+score(F₀)+score(siren cry)

has given a reliable indication of the level of pain suffered by the newborn by means of the following correspondence table, validated in literature:

| PainScore | Pain |
|---|---|
| 0 | Absent |
| 1-3 | Intermediate |
| 4-6 | High |

The prototype implementation of the analysis procedure has been made by using the software LabVIEW from the National Instruments.

The instrument has been successfully tested on the recordings of 57 crying newborns, whose pain level has been independently evaluated by using the DAN index, providing values in accordance with the ones of the prototype.

The preferred embodiments have been above described and some modifications of this invention have been suggested, but it should be understood that those skilled in the art can make other variations and changes, without so departing from the related scope of protection, as defined by the following claims.

1. An automatic method for measuring a baby's cry, comprising the following step:
A. having N samples p(i), for i=0, 1, . . . , (N−1), of an acoustic signal p(t) representing the cry, sampled at a sampling frequency f, for a period of duration P;
the method being characterised in that it assigns a score PainScore to the acoustic signal p(t) by means of a function AF of one or more acoustic parameters selected from the group comprising:
a root-mean-square or rms value pᵣₘₛ of the acoustic signal p(t) in the period P;
a fundamental or pitch frequency F₀ of the acoustic signal p(t), i.e. the minimum frequency at which a peak in the spectrum of the acoustic signal p(t) occurs in the period P; and
a configuration of amplitude and frequency modulation of the acoustic signal p(t) in the period P.

2. A method according to claim 1, wherein the duration P is not shorter than 20 seconds.

3. A method according to claim 1, wherein the number N of samples p(i) is equal to an involution of 2 (N=2^{A}).

4. A method according to claim 1, wherein the function AF depends on the rms value pᵣₘₛ of the acoustic signal p(t) in the period P that is normalised to its maximum amplitude pₘₐₓ.

5. A method according to claim 1, wherein the function AF is a linear combination of one or more terms, each one of which is a function of assigning a score to a respective parameter of said one or more acoustic parameters.

6. A method according to claim 5, wherein the function AF is a sum of said one or more terms.

7. A method according to claim 5, wherein said function of score assignment is an either continuous or discrete function.

8. A method according to claim 5, wherein said function of score assignment is a preferably monotonic not decreasing function of the respective acoustic parameter.

9. A method according to claim 4, wherein it comprises the following steps:
B.1 determining the maximum amplitude pₘₐₓ of the acoustic signal p(t) in the period P:
$${p}_{max} = {max}_{i = 0 , 1 , … , ( N - 1 )} \{ p ( i ) \}$$
B.2 calculating the rms value of the acoustic signal p(t) in the period P, normalised to its maximum amplitude pₘₐₓ:
$${p}_{rms}^{norm} = \sqrt{\frac{1}{N} {\sum }_{i = 0}^{( N - 1 )} {( \frac{p ( i )}{{p}_{max}} )}^{2}}$$
B.3 assigning a first score score(pᵣₘₛ^{norm}) to the normalised rms value pᵣₘₛ^{norm} by means of a first function g₁(pᵣₘₛ^{norm})
score(pᵣₘₛ^{norm})=g₁(pᵣₘₛ^{norm})
whereby the first score score(pᵣₘₛ^{norm}) is a term of the linear combination of the function AF giving the score PainScore to the acoustic signal p(t).

10. A method according to claim 9, wherein the first function g₁(pᵣₘₛ^{norm}) is equal to ([1]):
$${g}_{1} ( {p}_{rms}^{norm} ) = \frac{2}{π} arctan ( α ( {p}_{rms}^{norm} - β ) ) + 1$$

11. A method according to claim 10, wherein coefficients α and β are equal to ([2]):
α=100
β=0.14

12. A method according to claim 9, wherein the first function g₁(pᵣₘₛ^{norm}) is discrete, so that the possible values of pᵣₘₛ^{norm} are subdivided into at least two ranges to which a respective value of score(pᵣₘₛ^{norm}) corresponds.

13. A method according to claim 12, wherein the first function g₁(pᵣₘₛ^{norm}) is equal to:
$${g}_{1} ( {p}_{rms}^{norm} ) = \{ \begin{matrix}0 & for 0 \leq {p}_{rms}^{norm} < 0 , 1 \\ 1 & for 0 , 1 \leq {p}_{rms}^{norm} < 0 , 18 \\ 2 & for {p}_{rms}^{norm} \geq 0 , 18\end{matrix}$$

14. A method according to claim 4, wherein it comprises the following steps:
C.1 subdividing the N samples p(i) into M time intervals, of duration equal to D=P/M, each one of which comprising N_{D} samples p_{Hk}(j), with
N_{D}=N/M
C.2 calculating for each interval the digitised power spectrum of the signal:
S_{Hk}(j)=FT_{ND}{p_{Hk}(j)}
for j=0, 1, . . . , (N_{D}−1) and k=0, 1, . . . , (M−1)
where y(j)=FT_{Q}{x(j)} indicates the operator FT_{Q} transforming Q samples x(j) in the time domain to Q samples y(j) in the frequency domain;
C.3 calculating the mean spectrum S̅_̅{̅H̅k̅}̅(j) of the M spectra:
$$\overline{{S}_{Hk}} ( j ) = \frac{1}{M} {\sum }_{k = 0}^{M - 1} {S}_{Hk} ( j ) for j = 0 , 1 , … , ( {N}_{D} - 1 )$$
C.4 determining the mean value Sₘₑₐₙ of the mean spectrum S̅_̅{̅H̅k̅}̅(j) in a first frequency range included between two respective frequency limit values F₁ and F₂:
$${S}_{mean} = \overline{{S}_{Hk}} ( j ) = \frac{1}{( \frac{{F}_{2} - {F}_{1}}{{R}_{f}} + 1 )} {\sum }_{j = F 1 / Rf}^{F 2 / Rf} \overline{{S}_{Hk}} ( j )$$
where R_{f} is the frequency resolution of each spectrum:
R_{f}=fₛ/N_{D}
C.5 determining the pitch F₀ as the minimum frequency at which a peak of the mean power spectrum S̅_̅{̅H̅k̅}̅(j) occurs, the peak being a relative maximum of the spectrum having value larger than a first threshold T1:
F₀=R_{f}·min{j|max_relative[ S̅_̅{̅H̅k̅}̅(j)]>T1}
C.6 assigning a second score score(F₀) to the pitch value F₀ by means of a second function g₂(F₀):
score(F₀)=g₂(F₀)
whereby the second score score(F₀) is a term of the linear combination of the function AF giving the score PainScore to the acoustic signal p(t).

15. A method according to claim 14, wherein the first threshold T1 is equal to the sum of the mean value Sₘₑₐₙ of the mean spectrum S̅_̅{̅H̅k̅}̅(j) with an offset value Δ1.

16. A method according to claim 14, wherein the second function g₂(F₀) is equal to ([3]):
$${g}_{2} ( {F}_{0} ) = \frac{2}{π} arctan ( γ ( {F}_{0} - δ ) ) + 1$$

17. A method according to claim 16, wherein coefficients γ and δ are equal to ([4]):
γ=100
δ=0.4

18. A method according to claim 14, wherein the second function g₂(F₀) is equal to ([3]):
$${g}_{2} ( {F}_{0} ) = \{ \begin{matrix}0 & for {F}_{0} < {F}_{REF} \\ 2 & for {F}_{0} \geq {F}_{REF}\end{matrix}$$

19. A method according to claim 18, wherein F_{REF}=400 Hz.

20. A method according to claim 4, wherein it comprises the following steps:
C.1 subdividing the N samples p(i) into M time intervals, of duration equal to D=P/M, each one of which comprising N_{D} samples p_{Hk}(j), with
N_{D}=N/M
C.2 calculating for each interval the digitised power spectrum of the signal:
S_{Hk}(j)=FT_{ND}{p_{Hk}(j)}
for j=0, 1, . . . , (N_{D}−1) and k=0, 1, . . . , (M−1)
where y(j)=FT_{Q}{x(j)} indicates the operator FT_{Q} transforming Q samples x(j) in the time domain to Q samples y(j) in the frequency domain;
D.1 for each digitised power spectrum S_{Hk}(j), calculating the energy contribution E_{F3}_{_{—}}_{F4}(k) in a second frequency range included between two respective frequency limit values F₃ and F₄:
$${E}_{F3\_F4} ( k ) = {\sum }_{j = F 3 / Rf}^{F 4 / Rf} {S}_{Hk} ( j )$$
$$for k = 0 , 1 , … , ( M - 1 )$$
where R_{f} is the frequency resolution of each spectrum:
R_{f}=fₛ/N_{D}
D.2 calculating the mean value E̅_̅{̅F̅3̅}̅_̅{̅_̅}̅_̅{̅F̅4̅}̅ of the energy contribution E_{F3}_{_}_{F4}(k) in tempo:
$$\overline{{E}_{F3\_F4} ( k )} = \frac{1}{M} {\sum }_{k = 0}^{M - 1} {E}_{F3\_F4} ( k )$$
D.3 calculating the deviation ΔE_{F3}_{_{—}}_{F4}(k) of the energy contribution E_{F3}_{_{—}}_{F4}(k) in the second frequency range with respect to its mean value E̅_̅{̅F̅3̅}̅_̅{̅_̅}̅_̅{̅F̅4̅}̅:
ΔE_{F3}_{_{—}}_{F4}(k)=E_{F3}_{_{—}}_{F4}(k)− E̅_̅{̅F̅3̅}̅_̅{̅_̅}̅_̅{̅F̅4̅}̅
for k=0, 1, . . . , (M−1)
D.4 calculating the digitised power spectrum V^{F3}^{_{—}}^{F4}(k) of the deviation ΔE_{F3}_{_{—}}_{F4}(k):
V^{F3}^{_{—}}^{F4}(k)=FT_{M}{ΔE_{F3}_{_{—}}_{F4}(k)}
for k=0, 1, . . . , (M−1)
D.5 calculating the energy contribution V_{XTND}_{_{—}}_{F5}_{_{—}}_{F6}^{F3}^{_{—}}^{F4} of the spectrum V^{F3}^{_{—}}^{F4}(k) in a third frequency range included between two respective frequency limit values F₅ and F₆:
$${V}_{XTIND\_F5 \_F6}^{F3\_F4} = {\sum }_{k = F 5 / VRf}^{F 6 / VRf} {V}^{F3\_F4} ( k )$$
D.6 calculating the energy contribution V_{SHRT}_{_{—}}_{F7}_{_{—}}_{F8}^{F3}^{_{—}}^{F4} of the spectrum V^{F3}^{_{—}}^{F4}(k) in a fourth frequency range included between two respective frequency limit values F₇ and F₈:
$${V}_{SHRT\_F7 \_F8}^{F3\_F4} = {\sum }_{k = F 7 / VRf}^{F 8 / VRf} {V}^{F3\_F4} ( k )$$
D.7 assigning a third score score(sirencry) to the difference between said two energy contributions (V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}) by means of a third function g₃(V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}):
score(sirencry)=g₃(V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4})
whereby the third score score(sirencry) is a term of the linear combination of the function AF giving the score PainScore to the acoustic signal p(t).

21. A method according to claim 20, wherein the third function g₃(V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}) is discrete, with two intervals of membership for the difference (V_{XTND}_{_{—}}_{F5}_{_{—}}_{F6}^{F3}^{_{—}}^{F4}−V_{SHRT}_{_{—}}_{F7}_{_{—}}_{F8}^{F3}^{_{—}}^{F4}), to which a respective value of score score(sirencry) corresponds, the method further comprising the following steps:
D.8 verifying if the energy contribution V_{SHRT}_{_{—}}_{F7}_{_{—}}_{F8}^{F3}^{_{—}}^{F4} in the fourth frequency range is larger than a percentage threshold PT of the energy contribution V_{XTND}_{_{—}}_{F5}_{_{—}}_{F6}^{F3}^{_{—}}^{F4} in the third frequency range;
D.9 in the case when the verification of step D.8 gives a positive outcome, assigning a value equal to 2 to the third score:
score(siren cry)=2
D.10 in the case when the verification of step D.8 gives a negative outcome, assigning a null value to the third score:
score(siren cry)=0.

22. A method according to claim 21, wherein the percentage threshold PT is equal to 60%.

23. A method according to claim 20, wherein the following step is performed between steps D.3 and D.4:
D.11 applying a window W_{flat-top}(k) (for k=0, 1, . . . , (M−1)) to the deviation ΔE_{F3}_{_{—}}_{F4}(k).

24. A method according to claim 23, wherein the window W_{flat-top}(k) is a window having spectrum with flat top main lobe, or window flat-top.

25. A method according to claim 20, wherein the third score score(sirencry) is null in the case when the rms value pᵣₘₛ of the acoustic signal p(t) in the period P is lower than a second threshold T2.

26. A method according to claim 14, wherein the number M of time intervals is equal to an involution of 2: M=2^{B}, with B≦A.

27. A method according to claim 14, wherein step C.2 calculates for each interval the digitised power spectrum of the signal through a numerical Fourier transform.

28. A method according to claim 14, wherein the following step is performed between steps C.1 and C.2:
C.7 applying a window W_{H}(j) capable to eliminate spurious spectral characteristics caused by cutting the waveform off to each of the M time intervals, whereby:
p_{Hk}(j)=p(N_{D}·k+j)·W_{H}(j)
for j=0, 1, . . . , (N_{D}−1) and k=0, 1, . . . , (M−1)

29. A method according to claim 28, wherein said window is a Hanning window.

30. An apparatus for measuring a baby's cry, comprising processing means, wherein it is capable to perform the automatic method for measuring a baby's cry according to claim 1.

31. An apparatus according to claim 30, wherein it further comprises means for detecting acoustic signals, and sampling means, capable to sample said acoustic signals.
